(19) United States
(12) Patent Application Publication
(10) Pub. No.: US 2026/0168314 A1
(43) Pub. Date: Jun. 18, 2026

(54) METHOD FOR FORMING A CLOSED FRAME-SHAPED SPACER ON A GLASS SHEET FOR AN INSULATING GLASS PANE

(71) Applicant: Glaston Germany GmbH, Neuhausen-Hamberg (DE)

(72) Inventor: Heiko Bismarck, Engelsbrand (DE)

(73) Assignee: Glaston Germany GmbH, Neuhausen-Hamberg (DE)

(21) Appl. No.: 19/410,704

(22) Filed: Dec. 5, 2025

(30) Foreign Application Priority Data
Dec. 12, 2024 (DE) 102024137463.2

(51) Int. Cl. E06B 3/673; E06B 3/663

(52) U.S. Cl. CPC E06B 3/6733; E06B 3/66328

(57) ABSTRACT

A method is disclosed for forming a closed frame-shaped spacer on a glass sheet for an insulating glass pane by applying a spacer strand made of a pasty and subsequently solidifying plastic material to the glass sheet. The spacer strand is applied to the glass sheet in at least two layers lying on top of each other to form the spacer. The spacer strand is applied to the glass sheet in a first layer, and wherein the spacer strand is applied in a second layer on top of the spacer strand in the first layer. A start segment of the spacer strand in the first layer and an end segment in the last layer overlap at least partially.

### CROSS-REFERENCE TO RELATED APPLICATIONS

This application claims priority to the German application number 10 2024 137 463.2 filed on Dec. 12, 2024, the entire content of which is fully incorporated herein with this reference.

### DESCRIPTION

### Field of the Invention

The invention is based on a method for forming a closed frame-shaped spacer on a glass sheet for an insulating glass pane, and on an insulating glass pane comprising at least two glass sheets and a spacer arranged between them, which, due to its thickness, holds the two glass sheets at a predetermined distance to each other. The spacer is formed by applying a spacer strand consisting of a pasty and subsequently solidifying plastic material to the glass sheet. The spacer strand is applied to the glass sheet in at least two layers lying on top of each other to form the spacer.

### BACKGROUND OF THE INVENTION

A method for forming a closed frame-shaped spacer on a glass sheet for an insulating glass pane is known from DE 44 33 749 A1. Such a method is widely used in practice. Due to constantly growing requirements for the insulating effect of insulating glass panes, larger distances between two adjacent glass sheets of the insulating glass pane are required. When applying a spacer strand having a predetermined target thickness and consisting of a pasty and subsequently solidifying plastic material, it can happen that the spacer strand being still soft, deforms and sinks in the area of the upper and/or lower edge of the glass sheet due to its own weight, especially if the target thickness is greater than 18 mm.

DE 10 2019 123 700 A1 discloses an insulating glass pane and a method for its manufacture, in which a spacer strand is applied to a first glass sheet and a second spacer strand is applied to a second glass sheet. When applying the frame-shaped spacer, the closure section where the beginning and end of the spacer strand meet is always located at the same place, for example in the area of the lower left corner of the glass sheets. After application, one of the two glass sheets is rotated around an axis parallel to the plane of the glass sheet and then assembled with the other glass sheet in such a way that the two spacer strands lie on top of each other. After rotating one glass sheet, the closure section on this glass sheet is then located in the area of the lower right corner. After joining, closure sections on the spacer strand are thus visible in two corners of the insulating glass pane. This procedure requires a special design of the manufacturing device or production line, in particular a turning station for turning a standing glass sheet. In addition, a pressing station with two horizontal conveyors running parallel to each other is required, both of whose pressing plates are inclined in a V-shape in opposite directions to each other in order to support the two opposing glass sheets, cf. EP 2 802 727 B1. Consequently, this method cannot be carried out with the pressing stations and production lines commonly used in practice to date and has therefore not been put into practice.

A method and an insulating glass pane of the type mentioned at the beginning are known from WO 2019/076804 A1. The spacer contains at least two layers lying on top of each other and consisting of different transparent materials with different properties. At least one layer serves to stiffen the spacer and another layer serves to seal it. Start segment and end segment of the spacer strand in one layer abut in a dull joint.

It may be an object of the invention to provide an improved method for manufacturing an insulating glass pane and an improved insulating glass pane.

The object is achieved by a method having the features of claim 1 and an insulating glass pane having the features of claim 4. Advantageous further embodiments are subject of the dependent claims.

### SUMMARY OF THE INVENTION

A method according to the invention for forming a closed frame-shaped spacer on a glass sheet for an insulating glass pane is part of a process for manufacturing an insulating glass pane according to the invention. An insulating glass pane according to the invention contains at least two glass sheets and a frame spacer which is arranged between the two glass sheets and, due to its thickness, holds them at a predetermined distance to each other. The space between the two glass sheets can be filled with different media. In an insulating glass pane designed as a window pane, the space between the two glass sheets can be filled with a gas other than air, for example argon. In an insulating glass pane designed as fire-resistant glazing, the space between the two glass sheets can be filled with a gel, for example a saline hydrogel. The spacer is formed by applying a spacer strand to a glass sheet. The spacer strand is formed in a known manner from a paste-like plastic material that subsequently solidifies. The plastic material can be a thermoplastic material that solidifies simply by cooling. The plastic material can also be a reactively cross-linking material in which solidification occurs through a chemical reaction. The material of the spacer strand can be applied to the glass sheet in a predetermined target thickness using a nozzle. The nozzle can be moved along the edge of the glass sheet, depositing the spacer strand emerging from the nozzle onto the glass sheet in such a way that the beginning and end of the strand meet.

According to the invention, the spacer strand is applied to the glass sheet in two or more, in particular two to five, layers on top of each other to form the spacer. The spacer strand is applied to the glass sheet in a first layer. The spacer strand is then applied in a second layer on top of the spacer strand lying in the first layer. If the spacer is formed from only two layers, the second layer is also the last layer. The thickness of the spacer is formed by the multiple, in particular two, layers of the spacer strand applied on top of each other. The spacer strand has at least one start segment in the first layer and an end segment in the last layer. The end segment in the last layer overlaps at least partially with the start segment in the first layer. The finished spacer of the insulating glass pane thus has a section in which part of the start segment of the first layer and part of the end segment of the last layer are located. At least at one point, the thickness of a two-layer spacer is thus formed in part by the start segment in the first layer and in part by the end segment in the second layer.

According to the invention, the spacer strand is applied continuously from the first layer into the second layer, in particular, continuously from the first layer into the last layer. The spacer strand has at least one transition section, which is arranged between the start segment in a first of the at least two layers and the end segment in the last of the at least two layers. In particular, the spacer strand may have a transition section which is arranged between the start segment in the first layer and the end segment in the second layer. In the transition section, the spacer strand runs without interruption from one layer into the other, in particular from the first layer into the second layer. In the transition section, the thickness of the spacer strand can be changed from the target thickness of one layer to the target thickness of the other layer, in particular from the target thickness of the first layer to the target thickness of the second layer. In the area of the closure section of the frame-shaped spacer consisting of two layers, the total thickness is thus formed by the start segment in the first layer, the transition section lying on top of it, and the end segment of the second layer lying on top of the transition section.

The invention may have (but which are not necessary) significant advantages: (1) The total thickness of the spacer between the two glass sheets is formed by the sum of the thicknesses of all the layers of the spacer strand lying on top of each other. (2) By applying the spacer strand in at least two layers, the first layer can solidify over a longer period of time, so that its stability and load-bearing capacity are greater when the second layer is applied onto the first layer. (3) Undesirable deformation and/or sagging of horizontal areas of the frame-shaped spacer can be avoided even with large spacer thicknesses. This allows spacers with a thickness of 20 mm or more, particularly in the range from 25 mm to 60 mm, to be reliably manufactured. (4) In the finished insulating glass pane, at most a single closure section is visible on the frame-shaped spacer, which can improve the appearance.

In a further embodiment, the nozzle can be moved at least twice around the edge of the glass sheet, applying the spacer strand emerging from the nozzle to the glass sheet in at least two layers lying directly on top of each other. The thickness of the spacer strand as it emerges from the nozzle can be increased at the beginning over a predetermined length from zero to the target thickness of the first layer and reduced at the end of the spacer strand from the target thickness of the last layer to zero. The thickness of the spacer strand in the second or further layers can be greater than the thickness of the spacer strand in the first layer, in particular by a factor of 1.2 to 1.6. As a result, the cross-section of the spacer strand in the first layer is relatively small, so that the first layer cools relatively quickly on the cool glass sheet. The first layer can thus form a stable base for applying the second layer after a relatively short time. This can prevent unwanted deformations and/or sagging of the spacer in a particularly effective manner. The end segment in the last layer may have an offset from the start segment in the first layer. The end segment in the last layer may be longer than the start segment in the first layer.

The start segment in the first layer and the end segment in the last layer may each be wedge-shaped. The start segment in the first layer may have a first inclined surface. The end segment in the last layer may have a second inclined surface. The first inclined surface and the second inclined surface may be inclined in the same direction with respect to the glass sheet surface of the finished insulating glass pane. An angle from the glass sheet surface to the first inclined surface and/or the second inclined surface may be 45° or less, in particular 25° or less. The first inclined surface and the second inclined surface may have an angle of at most 10°, in particular at most 5°, to each other. The second inclined surface may be longer than the first inclined surface. The wedge-shaped start segment may be formed by increasing the thickness of the spacer strand from zero to the target thickness over a distance having a predetermined length as it emerges from the nozzle. The wedge shape of the end segment can be complementary to the wedge shape of the start segment. For this purpose, in the end segment, the thickness of the spacer strand can be reduced from the target thickness to zero over a distance having a predetermined length as it emerges from the nozzle. In particular, the predetermined length can be 3 cm to 10 cm. The nozzle may have an exit opening having a substantially rectangular exit cross-section and a slider for closing the exit opening.

In a further embodiment, the spacer can be applied to the glass sheet in such a way that in one layer a beginning and an end of the spacer strand meet. The spacer strand can have a start segment in the first layer, an end segment in the first layer, and a start segment in the second layer. The spacer strand can contain an end segment in the second layer. The start segment of the second layer is applied onto the end segment of the first layer. Thus, the start segment of the second layer and the end segment of the first layer overlap at least partially. The thickness of the spacer strand can be increased from zero to the target thickness of the first layer over a distance having a predetermined length at the beginning of the first layer as it emerges the nozzle, and complementarily reduced from the target thickness to zero over the same distance at the end of the first layer. The end segment of the first layer overlaps the start segment of the first layer at least partially.

### BRIEF DESCRIPTION OF THE DRAWINGS

Further details and advantages of the invention are explained in embodiments of the invention with reference to the accompanying drawings. Identical and corresponding components are provided with corresponding reference numerals.

FIG. 1 shows a schematic side view of an insulating glass pane according to the invention with a spacer applied in two layers,

FIG. 2 shows a perspective view of the insulating glass pane of FIG. 1 during manufacture,

FIG. 3 shows an enlarged detail of a schematic side view of an insulating glass pane according to the invention,

FIG. 4 shows a perspective view of a closure section in the corner area of a spacer applied in two layers,

FIG. 5 shows a representation similar to FIG. 4 of a different design of the closure section.

### DETAILED DESCRIPTION OF EMBODIMENTS OF THE INVENTION

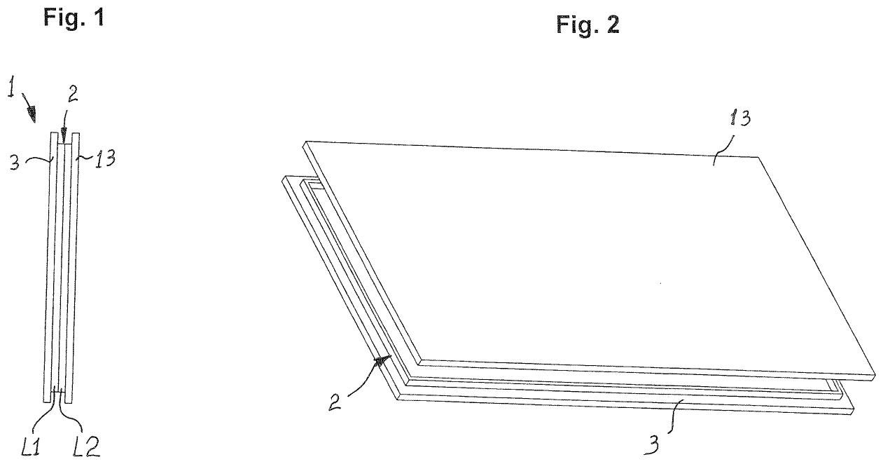

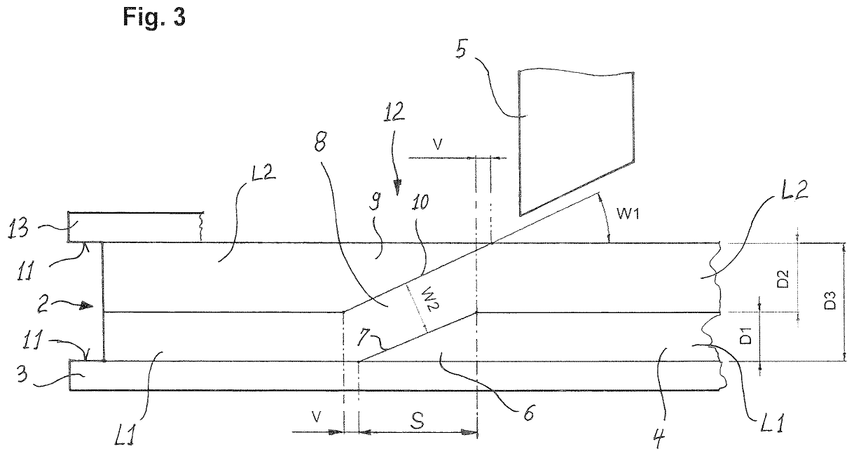

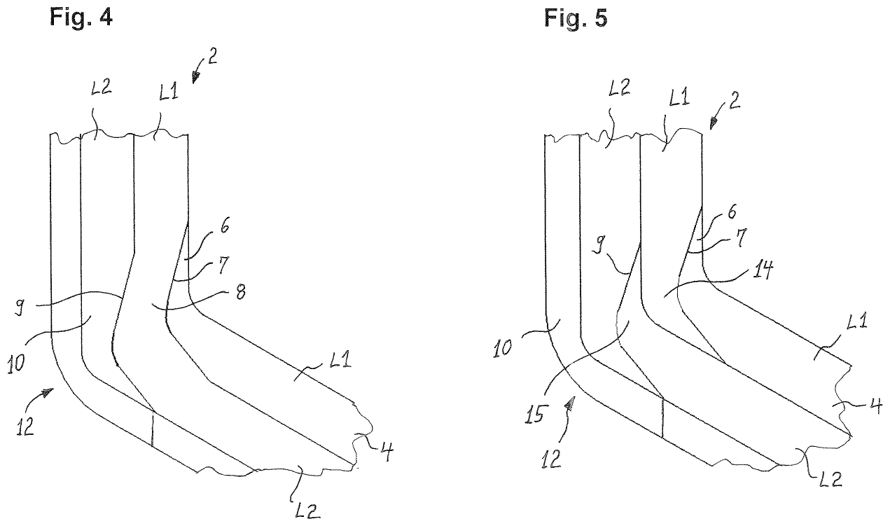

An insulating glass pane 1 contains a frame-shaped spacer 2 on a glass sheet 3. With the aid of a nozzle 5, which is only shown schematically, the spacer strand 4 is applied to the glass sheet 3 in two layers L1 and L2 lying directly on top of each other to form the spacer 2. The first layer L1 is applied directly onto the glass sheet 3. The second layer L2 forms the last layer of the spacer 2. In a start segment 6, the thickness of the spacer strand 4 is increased to the target thickness D1 of the first layer L1 over a distance S of predetermined length along a first inclined surface 7. The nozzle 5 is moved around the glass sheet 3. When the nozzle 5 reaches the start segment 6 again, the spacer strand 4 is applied to the inclined surface 7 without interruption in a transition section 8, see FIGS. 3 and 4. The second layer L2 is then applied without interruption. In the area of the transition section 8, the thickness of the spacer strand 4 emerging from the nozzle 5 is increased to the target thickness D2 of the second layer. The nozzle 5 is then moved around the circumference of the glass sheet 3 a second time, thereby applying the second layer L2 onto the spacer strand 4 already lying in the first layer L1. In an end segment 9, the target thickness of the spacer strand 4 is reduced from D2 to zero along a second inclined surface 10. The reduction in target thickness in the area of the end segment 9 takes place over a distance that is longer than the distance S of the start segment 6. The end segment 9 is arranged slightly offset from the start segment 6 so that there is an offset V of equal size at the start and end. The inclined surfaces 7 and 10 have an angle W1 of approximately 25° to a glass sheet surface 11 and are inclined in the same direction. An angle W2 between the two inclined surfaces 7 and 10 can be in the range from 0° to 5°. The total thickness D3 =D1+D2 can be in the range from 20 mm to 50 mm, in particular in the range from 27 mm to 32 mm. If the layers L1 and L2 are of equal thickness, the two inclined surfaces 7 and 10 run parallel to each other, and the spacer strand 4 is applied with a constant target thickness in the transition section 8 also. The transition section 8 is thus arranged between the inclined surface 7 of the start segment 6 and the inclined surface 10 of the end segment 9 and extends continuously from the first layer L1 into the second layer L2. The closure section 12 of the spacer 2 comprises the start segment 6, the transition section 8, and the end segment 9 and, in the embodiment shown in FIG. 3, is located in a straight area of the spacer 2. In the embodiment shown in FIG. 4, the closure section 12 is located in the corner area of the glass sheet 3. After the spacer strand 4 has been completely applied to the glass sheet 3, the latter is joined in a manner known per se with another glass sheet 13, see FIG. 2, to form an insulating glass pane 1, so that the spacer 2 holds the two glass sheets 3 and 13 at a predetermined distance to each other, see FIG. 1.

In the embodiment shown in FIG. 5, the first layer L1 of the spacer strand 4 is initially terminated by an end segment 14. The application of the spacer strand 2 is interrupted. Subsequently, the second layer L2 is started with a start segment 15, which is applied to the end segment 9 of the first layer so that the start segment 14 overlaps the end segment 9. The first inclined surface 7 runs parallel to the second inclined surface 10 here. A third layer (not shown) can be applied in a way according to FIG. 4 so that a transition section 9 extends from the second layer L2 in to the third layer (not shown).

### LIST OF REFERENCE SYMBOLS

1 Insulating glass pane
2 Spacer
3 Glass sheet
4 Spacer strand
5 Nozzle
6 Start segment
7 First inclined surface
8 Transition section
9 End segment
10 Second inclined surface
11 Glass sheet surface
12 Closure section
13 Glass sheet
14 End segment
15 Start segment
D1 Thickness L1
D2 Thickness L2
D3 Total thickness
L1 First layer
L2 Second layer
S Segment
W1 Angle
W2 Angle

What is claimed is:

1. A method for forming a closed frame-shaped spacer on a glass sheet for an insulating glass pane, comprising the steps of:
applying a spacer strand consisting of a pasty and subsequently solidifying plastic material to the glass sheet;
wherein the spacer strand is applied to the glass sheet in at least two layers lying on top of each other to form the spacer;
wherein the spacer strand is applied onto the glass sheet in a first layer, and wherein the spacer strand in a second layer is applied onto the spacer strand in the first layer; and
wherein the spacer strand is applied continuously from one layer of the at least two layers lying on top of each other into another layer of the at least two layers lying on top of each other.

2. The method according to claim 1, wherein a nozzle is moved along the edge of the glass sheet at least twice around the glass sheet and thereby applies the spacer strand emerging from the nozzle to the glass sheet in at least two layers lying on top of each other, wherein the thickness of the spacer strand emerging from the nozzle is increased at the beginning over a segment having a predetermined length from 0 to the target thickness of the first layer and is reduced from the target thickness of the last layer to 0 at the end of the spacer strand.

3. The method according to claim 1, wherein the spacer strand is applied having a start segment in the first layer, an end segment in the first layer and a start segment in the second layer, wherein the start segment of the second layer is applied at least partially onto the end segment of the first layer.

4. An insulating glass pane, comprising:
at least two glass sheets and a spacer arranged between them, which, due to its thickness, holds the two glass sheets at a predetermined distance to each other;
wherein the thickness of the spacer is formed by at least two layers applied one on top of the other of a spacer strand comprising a start segment in the first layer and an end segment in the last layer;
wherein the start segment in the first layer and the end segment in the last layer at least partially overlap;
wherein at least one transition section of the spacer strand is arranged between the start segment in one layer of the at least two layers and the end segment in another layer of the at least two layers; and
wherein the spacer strand in said transition section extends without interruption from said one layer into said other layer.

5. The insulating glass pane according to claim 4, wherein a transition section of the spacer strand is arranged between the start segment of the first layer and the end segment of the second layer, and wherein the spacer strand in said transition section extends without interruption from the first layer into the second layer.

6. The insulating glass pane according to claim 4, wherein the start segment in the first layer has a first inclined surface, wherein the end segment in the last layer has a second inclined surface, and wherein the first inclined surface and the second inclined surface are inclined in the same direction.

7. The insulating glass pane according to claim 4, wherein the spacer strand has an end segment in the first layer and a start segment in a second layer, wherein the end segment of the first layer and the start segment of the first layer at least partially overlap, and wherein the start segment of the second layer and the end segment of the first layer at least partially overlap.
